(19) United States
(12) Patent Application Publication
(10) Pub. No.: US 2008/0091493 A1
(43) Pub. Date: Apr. 17, 2008

(54) Method and system for gathering and potentially sharing workflows

(75) Inventor: Eric Holmstrom, Dexter, MI (US)

Correspondence Address: SCHIFF HARDIN, LLP;PATENT DEPARTMENT, 6600 SEARS TOWER, CHICAGO, IL, 60606-6473, US

(73) Assignee: Siemens Aktiengesellschaft

(21) Appl. No.: 11/540,623

(22) Filed: Sep. 29, 2006

(51) Int. Cl. G05B 19/418

(52) U.S. Cl. 705/8

(57) ABSTRACT

A method and system for receiving workflows, such as workflows of a medical facility, and potentially for sharing the workflows with others includes a portal with an interface to receive workflows of a user accessing the portal. The workflows may either be drawn at the interface using drawing tools or may be uploaded by the user to the portal. Workflows of other medical facilities are viewable for comparison to each other and to the workflow of the user.

### BACKGROUND OF THE INVENTION

1. Field of the Invention

The present invention relates generally to method for gathering workflows of, for example, medical facilities, and potentially sharing the workflows with medical facilities, as well as to a system for carrying out the method.

2. Description of the Related Art

Various businesses and institutions use workflows, which are sometimes illustrated by workflow diagrams, for understanding the operation of the business or institution and potentially for improving the business processes. Workflows are particularly important in medical care performed at medical facilities, such as clinics and hospitals, since the workflow not only impacts the profits of the facility but also may effect the time and efficiency of diagnosis and treatment of the patients as well as the comfort and care of the patients themselves.

Many medical facilities generate workflows for various aspects of their operation. One example of a workflow used by a medical facility is a workflow of patient intake and care at an emergency room, while another may be the patient processing at a imaging lab, such as an MRI (Magnetic Resonance Imaging) lab. Such workflows can be studied by the management and by outside consultants for ways to improve the efficiency and effectiveness of the processes in the workflows. This approach relies on the experience of the management and the outside consultants to find problems and improvements in the workflow. Little opportunity is available to compare the workflows of different facilities with one another.

### SUMMARY OF THE INVENTION

The present invention provides a method and system for gathering workflows and potentially for sharing the workflows with others. In one embodiment, a portal is provided at which users accessing the portal may provide workflows. The workflows are stored for review and comparison. At least some of the workflows are preferably identified as available for sharing, and users of the portal may access the sharable workflows. A preferred embodiment of the invention gathers and potentially shares workflows of medical facilities.

In a preferred embodiment, the portal for gathering the workflows is an Internet site, preferably a website. The user of the website can upload or input workflows and can view or otherwise access the workflows of others for comparison to the workflow of the user's facility, for example.

### BRIEF DESCRIPTION OF THE DRAWINGS

FIG. 1 is a functional block diagram of a user accessing a portal, such as a website on the Internet, for providing and viewing workflows;

FIG. 2 is a schematic diagram of an example of a computer display of a portal page showing a workflow input;

FIG. 3 is a schematic diagram of an example of a computer display showing user questions;

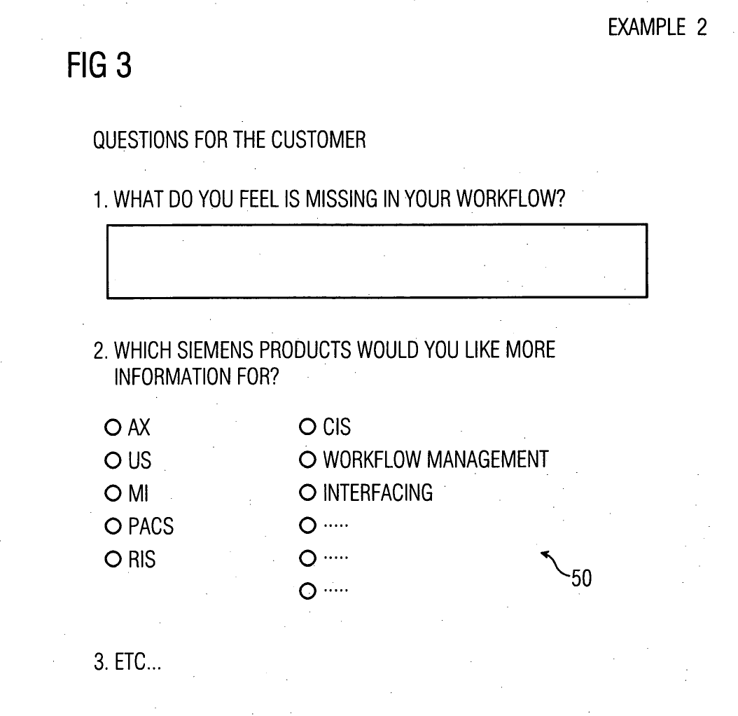

FIG. 4 is a schematic diagram of an example of an input screen for standards and integration;

FIG. 5 is a schematic diagram of an example of a customer profile input screen; and

FIG. 6 is a schematic diagram of an example of a multiple facility diagram screen.

### DETAILED DESCRIPTION OF THE PREFERRED EMBODIMENTS

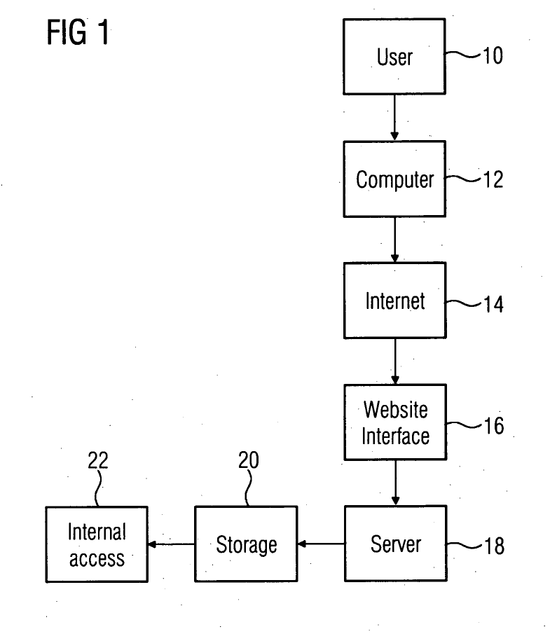

Referring first to FIG. 1, a block diagram shows a user 10 that may be the personnel of a medical facility, a customer of a medical equipment or supply company or any other interested person, uses a computer 12 to access the Internet 14 and connect to a website interface 16 of a portal that is provided on a server 18. The server 18 is connected to a storage where user provided information, such as a workflow input by the user, is stored and where information for access by the user 10, such as a workflow of another facility, is also stored. The storage 20 may have an internal access 22 by which the operator of the portal may input workflows and other data and by which the operator may retrieve workflow and other data provided by the users.

The present method and system provides, in a preferred embodiment, a portal at an Internet website 16 where medical facility personnel or other users 10 may provide workflows of their processes, including patient workflows, study workflows, or other workflows of the medial facility. The users 10 may designate the provided workflows as private or public. If designated as public, others may view or otherwise access the workflows, potentially for comparison to their own workflows, for evaluating staffing or equipment needs, or for other purposes.

Although described in the following as an Internet website, the portal may be accessed by the users instead via an intranet or via other wired or wireless communications channels. The portal need not be web based, although the World Wide Web (WWW) is currently the preferred site for the portal. The user interface 16 of the portal is, in one embodiment, written in a language or protocol using hypertext, such as HTTP, and potentially utilizes application platforms such as JAVA or other applets, applications or modular programs for components of the portal site. The site may be presented in a number of different designs and configurations; the illustrations being provided herein merely as one example of an interface design.

The portal of one embodiment is provided at the domain of a medical equipment company that provides equipment which is used in patient treatment and so would be used in many workflows of the medical facilities. The portal provider thereby gains incite into the needs of the medical facilities, those that are current or past customers of the company and those who have not been customers of the company, so that the product managers may more effectively address the needs of the medical community in general. Product decisions may be based on information gathered at the portal. Future products may be designed to address needs that become apparent from a study of the workflows.

It is contemplated to initially provide a number of workflows at the portal to that even early users of the portal have access to at least some workflows. The provider or operator of the portal may stock the portal with workflows, such as workflows from medical facilities that are known to the provider, via the internal access 22. In many instances, a medical facility will provide workflows to a consultant, for example, as part of a study of the facilities structure and procedures. Workflows collected in this manner may be provided to the portal initially and thereafter as further workflow information is obtained. Workflows of well known medical facilities, such as the Mayo Clinic or the Cleveland Clinic, provided at the portal will serve to draw users to the portal.

The user 10 of the portal may wish to provide workflows to the portal as part of a plan to change workflows, change the facility structure or layout, obtain different equipment, change staffing or work assignments, or change procedures. Workflows are often generated as part of the building or remodeling of the facility, or when adding new equipment or incorporating new technology into the patient treatment processes, records keeping, accounting, or other processes at the facility. The workflows provided by the user to the portal may be reviewed by the provider of the portal, by consultants and equipment providers, or by others who have an interest in the workflows. The user may provide comments with the workflows the user is providing to aid reviewers in understanding the workflows. The reviewers, on the other hand, may provide information and comments on the workflows directly to the user who provided the workflow, or may provide the comments to the portal for either private or public view, such as by posting the comments on a comment section of the portal.

It is also foreseen that other users of the portal, such as personnel at other medical facilities, may provide information and comments on the workflows as well. In this way, the user who offers the workflows for public access receives feedback on the workflows and may potentially improve the workflows, or more precisely, improve the procedures and operations at the medical facility. An option may be provided at the portal to enable the user to solicit input from others or to invite comments or offers from providers of equipment. A further benefit is that the user 10 contemplating a change in a workflow may find another facility that already uses the contemplated changed workflow and may be able to find out whether that changed workflow is successful or not.

It is foreseen that the website 16 may be interactive and may provide automated suggestions for improvements in the workflow or in the medical facility itself when the workflow is provided by the user. Solutions that are available for the medical facility may be noted.

As an incentive to users 10 to provide their own workflows to the portal, the user's access to review other workflows or to use other features of the portal may be limited until the user provides one or more workflows of their own to the portal. For instance, the user may be blocked from seeing other workflows, or may only see limited numbers of workflows until a predetermined number of workflows have been provided by the user.

The workflows may be in any of several different forms. For example, the workflow may include block diagrams, process flow charts, text descriptions, and the like. The workflows may be labeled or tagged with the identity of the submitter, the identity of the medical facility or other identifying information, the identify of equipment being used to perform steps in the workflow, or information relating to the medical facility layout, staff, procedures, or environment. The workflows preferably identify the subject matter that they relate to, such as a workflow for patient admissions, workflow by cardiac care, workflow for CT imaging, etc. The workflows may also relate to studies being conducted at the medical facility, or to special circumstances such as handling catastrophic events, addressing temporary situations, or the like. For instance, a medical facility anticipating a large influx of people for a special event being held in the vicinity of the facility may use workflows to prepare for the increased burden on their facility and staff. It would be helpful if the medical facility could see how other facilities have addressed such a problem by examining their workflows so that these ideas could be adopted by that medical facility. The greatest utility is likely to come in streamlining the day-to-day operations of the medical facility, however.

The preferred workflows include numbering or other identification for portions of the workflows. Each step may be identified or numbered, or groups or categories of steps may be numbered or identified. It is preferred that the workflow include information on the type of equipment or tools being used at each stage of the workflow. For instance, one make or model of imaging apparatus may have inherent limitations in that particular workflow processes are required for its use, while another may have altogether different workflow processes for use.

The accumulated workflows at the portal may be compared to one another so that, for example, trends or common features can be found. Such common features among workflows of different facilities may have been previously unrecognized, and my lead to new equipment being provided or developed to meet the trend, or to training to better handle the new trend. It is also possible that the common features may be recognized as generally accepted processes and that others could adopt. Just as important, the comparison may recognize differences or aberrations in the workflows. The differences or aberrations may represent a new and better direction for addressing a problem that is not yet recognized by others, or may represent a procedure at one or more facility that does not work as well as other procedures and should be changed. In any event, an understanding can be gleaned from the comparison of the workflows.

In one embodiment of the portal, the portal or website 16 includes tools to assist the user in providing the workflow to the portal. For example, tools and templates for drawing block diagrams and flowcharts may be provided. A toolset similar to the flowchart and diagram drawing program Microsoft Visio may be used. The workflow is thereby generated and provided by the user while visiting the website. It is also contemplated that a user 10 is able to return to the portal to edit a previously input workflow.

However, it may be more conducive to receiving more detailed and carefully thought-out workflows if the user can upload already prepared workflows. To accomplish this, the portal includes means for facilitating uploading of workflows. Although the workflows may be in any of several different forms, a preferred embodiment receives workflows in one or more common formats so that all users can view them. The website may include viewer programs or applets for viewing the formats of workflows available at the portal, or may direct the user to sites where viewers can by obtained.

For those workflows that are that are available to the public through the portal, users 10 of the website 16 can learn what other medial facilities are doing by seeing other workflows. Product developers can develop new products to address any workflow problems or to better accommodate the workflows that are in common or regular use. The product developers, consultants, or even sales people who previously had to visit a medical facility to understand the workflow of the facility now need only visit the portal to learn information about the facility.

Alternative embodiments provide that the portal is either fully accessible by the public, or limits access to only selected users, such as by requiring registration with a user name and password for access. Different levels of access may be provided for different users, with operators and/or providers having a greater level of access than other users. Potentially, users who upload more workflows or who are customers of the portal provider may have greater access.

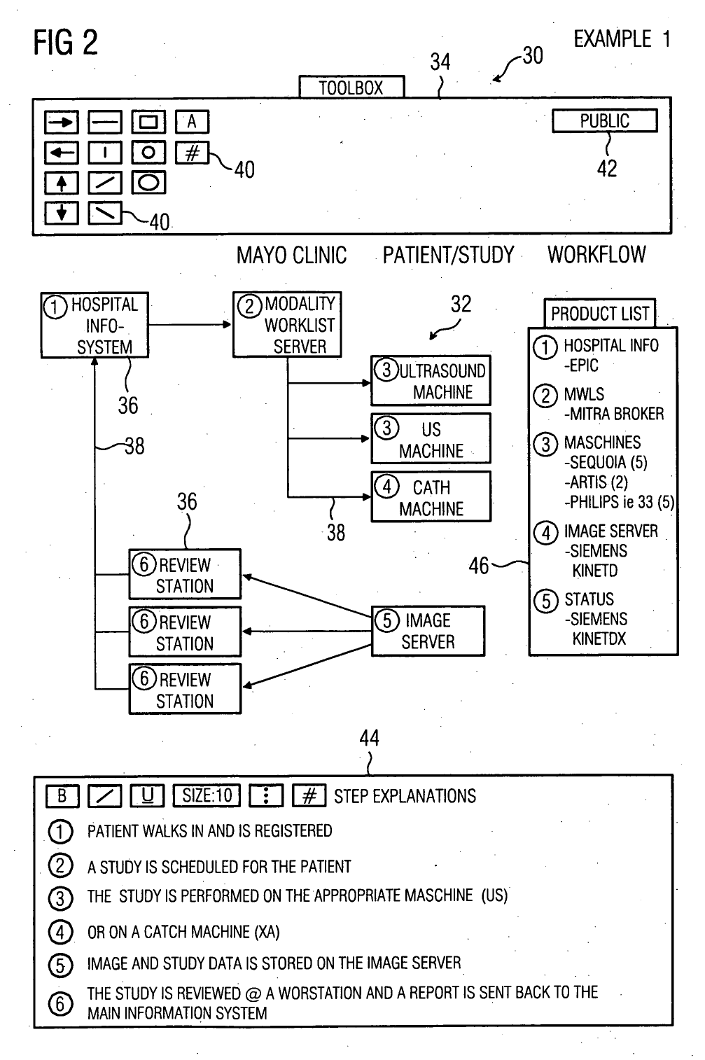

With reference now to FIG. 2, a display screen 30 of a website computer interface 16 to the portal is shown. The display screen 30 is in the preferred embodiment viewed on a computer 12 connected via the Internet 14 to a website 16 that serves as the interface to the portal. The user 10 of the portal may be considered in some circumstances to be a customer, and so the term customer is used interchangeably with user in the following.

FIG. 2 shows a workflow diagram 32 as an example that has been input on the web interface display 30 by a customer using a toolbox 34 to build the a block diagram of their workflow with items 36 linked by lines or arrows 38. The block diagrams are similar to Microsoft's Visio but it's available on the web portal instead. The top of the display includes the toolbox 34 of drawing tools for use by the user. The top section isn't necessarily where the toolbox 34 would be placed in every instance but it is shown as such in this example. The toolbox 34 has buttons 40 to press which provide different functions. If the mouse or other cursor or pointing device of the user is placed over a button 40 a popup message appears that gives the button name and a brief description on how to use it. The buttons 40 include things like: labels, rectangles, diamonds, circles, ovals, arrows, numbering, etc. The button 42 in the upper right corner of the toolbox says “public” identifying that the diagram is for public sharing with other customers. If the button 42 is clicked or selected, the workflow is marked instead as “private” so that the diagram should not be shared but only available to the user that input it and the operator of the portal. Putting the mouse or other pointer over any button or area of the display provides a description of what the button will do. It's very likely that the public/private feature might be applied to the different subsections of this page example (i.e. for the product list, for the explanations, and for the diagram workflow).

The bottom of the display has an area 44 with explanations. The bottom of the display isn't necessarily the location of the explanations area but it is in this example. The explanations section is an area that is provided for the customer for freehand typing. The customer might choose to freehand everything in their own words for their workflow or they might choose the # or numbering button to automatically create sub-sections which they can fill in to explain each of the items in their workflow diagram which they numbered. This section preferably has a toolset for basic word processing features such as: bold font, italic font, underlines font, font size, bullet points, etc.

A product list section 46 on the right is an example of a product list which might get auto-populated with the labels for those items that were assigned numbers by the customer in their workflow diagram. Each label on the right could have a bullet point below it where the customer could provide the actual product name, brand, and version information for that piece of their workflow. If the customer hits enter after each entry or bullet point, a new bullet point is added for additional systems if applicable to that item in the diagram. This would provide a summary of vendor products to the portal operator as well as to other customers if the profile is marked as available to the public.

These workflow diagrams are date/time stamped by the web portal to identify when they were last accurate. The workflows can be re-verified by the customer with ease using a corresponding button on the display.

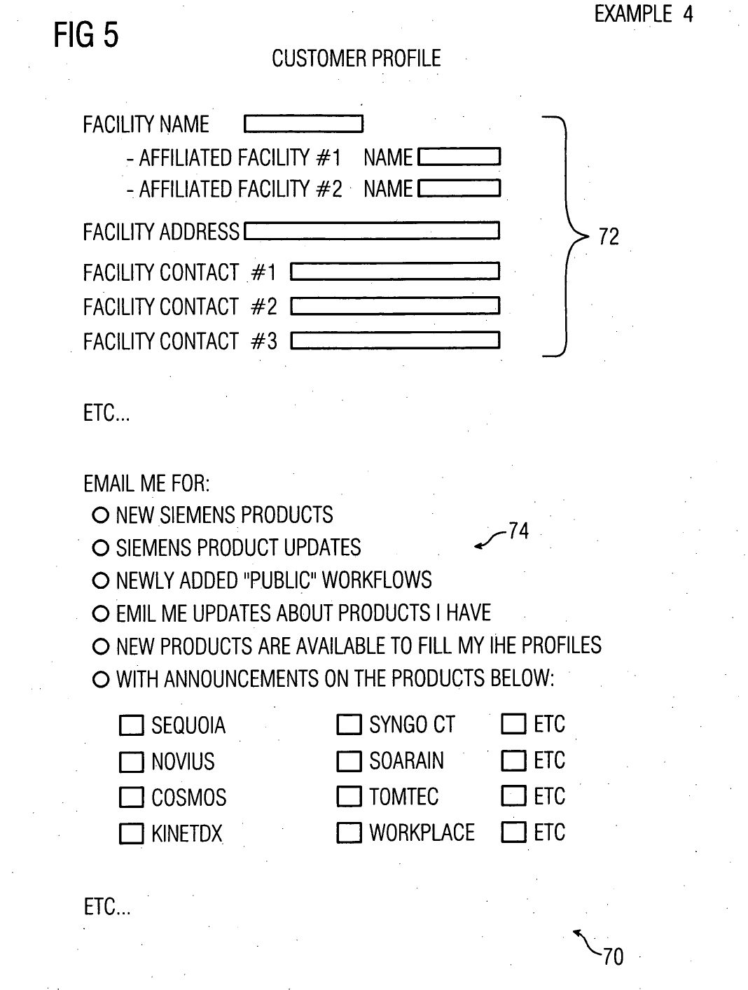

It's possible that the user will have multiple diagrams for the multiple facilities in their hospital network. A larger picture showing the high level information as to how those facilities are linked would be used for an overall view. See FIG. 5.

In FIG. 2 is a display of an input display 50 for questions for the customer. This section is similar to other questionnaires on the Internet. It provides a list of key questions that may be important to ask customers. The customers have the choice to optionally answer the questions or not.

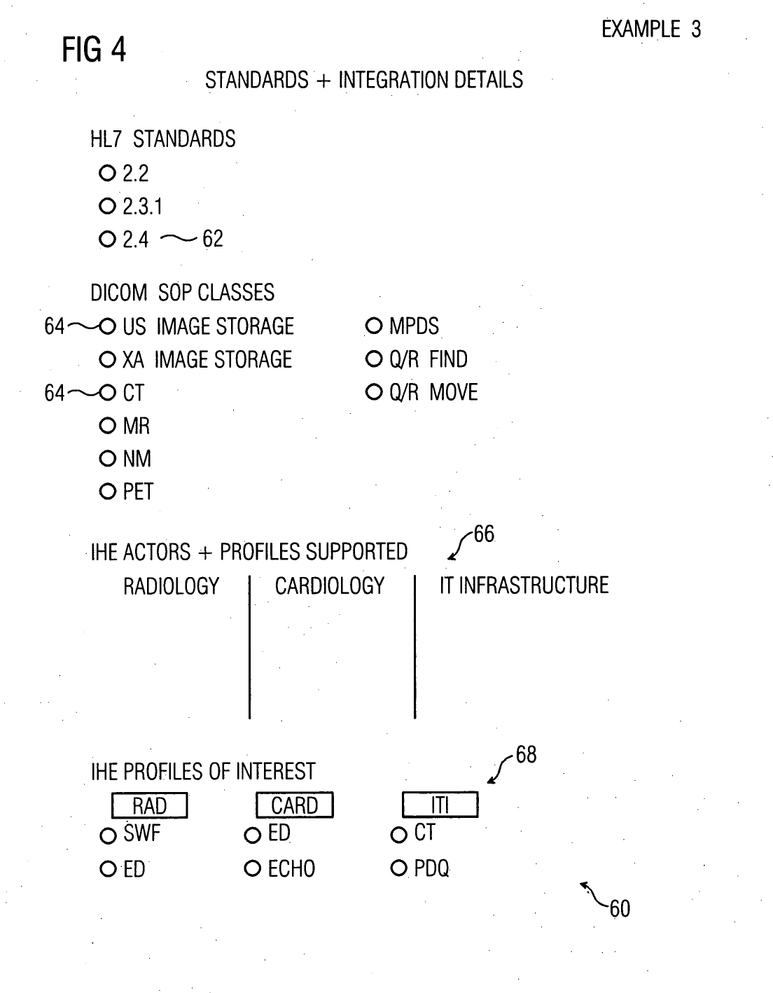

FIG. 4 shows a standards and integration details display 60. This section provides to the customer a list of various standards and initiatives currently used in the field. Under each standard or initiative section would be a list of choices for the customer to select if they are actually using those pieces of the standard.

For example, the entire hospital network might be using the HL7 version 2.4 standard for their HL7 communication, so the customer would only select that choice, at 62. However, for DICOM the customer is using multiple SOP Classes such as US and CT Image Storage Query/Retrieve among many more—so they would select all those that apply, as shown at 64. The IHE initiatives are becoming more popular as time goes on and this section 66 allows the customer to select which IHE Profiles they have full or partial support for and under each profile which actors they have support for.

One key piece to this section is the user “interests”, at 68. For IHE in particular the user might be interested in other profiles outside of what they currently support or perhaps have just become actors within the profile that they are missing and need. This type of information will the operator to have the right people contact the customer.

FIG. 5 enables a customer to input a profile at a display screen 70. This section is a common profile section. The customer can input their facility name, address and contact information at section 72, as well as multiple entries for any affiliated facilities in their hospital network along with the addresses and contact information to those facilities as well. The information here is to allow the operator to have information to contact the customer to answer any questions, send a thank you notice via email or mail for the workflow diagram, and possibly to send reminders for re-verifying the accuracy of the diagrams each year or defined period of time.

In section 74, the customers may indicate a desire to receive email updates on new products or invitations to meetings or seminars. Customers can select from a list of choices for when to receive automatic emails or manual emails from sales contacts when things become available. The emails or mail may relate to the availability of a product that fulfills their request for an IHE profile or actor or an update for a product they already have.

One key thing here is that all operator company products could be put in a database and provided to the customer in a list of choices to select for those they have or are interested in receiving email updates for them. This piece could be a big plus for the operator to keep on top of things with the products their customers have on an automated scale instead of phone calls from sales contacts.

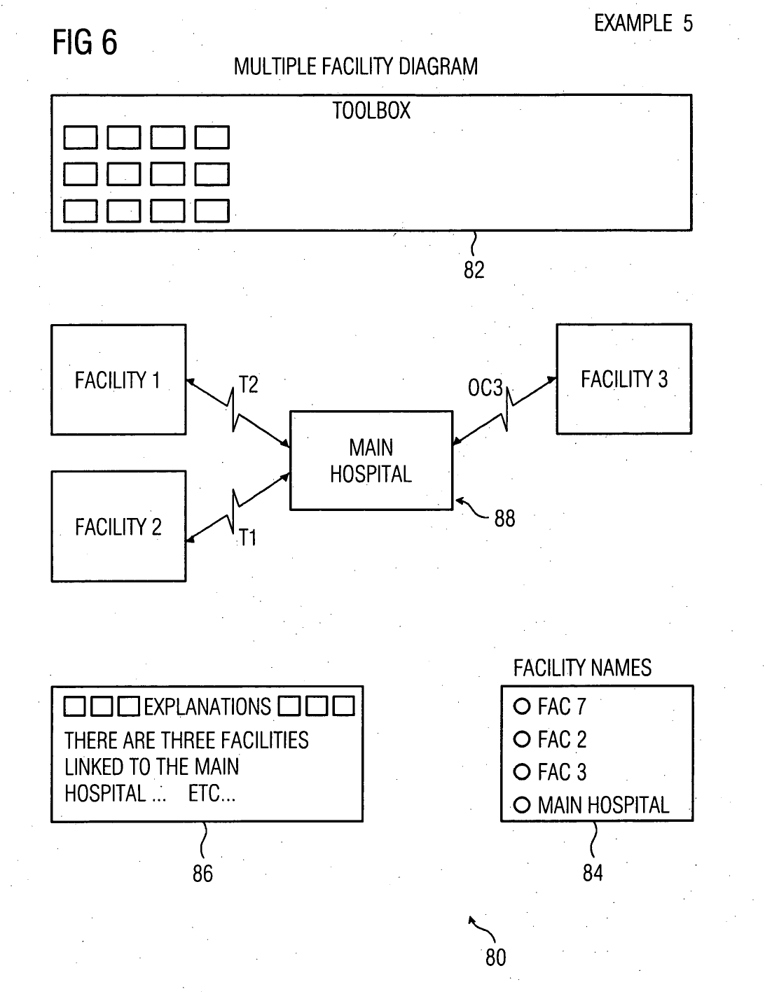

FIG. 6 permits the input of multiple facility diagrams at a facilities screen 80. This section is very similar to FIG. 1. It shares similar tools 82, the product list becomes the facility list 84 and there is also an explanations area 86 for the customer to describe the linkage and workflow 88 between facilities. The tools might slightly differ to include relevant things to this perspective such as arrows with a lightning symbol in them to signify an internet connection with labels for the speed such as “T1, T3, OC3, OC12, etc”.

Thus, there is shown and described a system and method for providing a portal to permit input of workflows of medical facilities, sharing of workflows, comparing of workflows and improving of workflows. Although the present examples are described for medical facilities, the principles of the invention enable the application to a wide variety of other fields, facilities and industries.

Although other modifications and changes may be suggested by those skilled in the art, it is the intention of the inventors to embody within the patent warranted hereon all changes and modifications as reasonably and properly come within the scope of their contribution to the art.

We claim:

1. A method for receiving workflows, comprising:
a portal on a network;
an interface operable upon access to said portal by a user, said interface enabling the user to input a workflow to the portal; and
a storage connected to said portal in which the workflow is stored after being input by the user.

2. A method as claimed in claim 1, wherein said workflows are workflows of medical facilities.

3. A method as claimed in claim 1, wherein said interface includes an input screen with drawing tools for a user to draw a workflow.

4. A method as claimed in claim 1, wherein said interface includes an input screen to receive an uploaded workflow.

5. A method as claimed in claim 1, wherein said interface includes a command to permit a user to indicate that a workflow provided to the portal by the use as either publicly accessible or not publicly accessible at the portal.

6. A method as claimed in claim 1, further comprising the steps of:
displaying workflows of other users to the user while the user accesses the portal.

7. A method for providing workflows to a portal, comprising the steps of:
accessing a portal;
providing a workflow to the portal for storage at the portal; and
indicating the provided workflow as either publicly accessible at the portal or not publicly accessible at the portal.

8. A method as claimed in claim 7, wherein said step of providing the workflow includes drawing the workflow using drawing tools while accessing the portal.

9. A method as claimed in claim 7, wherein said step of providing the workflow includes uploading a prepared workflow to the portal.

10. A system for accepting workflows from users, comprising:
a server connected to a network;
an interface on the server, said interface interactively operating with a user's computer when accessed by the user, the interface including:
a drawing input screen for receiving a workflow drawing by the user;
a public/private indicator for operation by the user to mark the workflow drawing as either public or private; and
a storage connected to said server on which is stored workflows provided by the user to the interface.
